(19) United States
(12) Patent Application Publication
(10) Pub. No.: US 2011/0070774 A1
(43) Pub. Date: Mar. 24, 2011

(54) COMPUTER ENCLOSURE

(75) Inventor: SONG HUANG, Shenzhen City (CN)

(73) Assignees: HONG FU JIN PRECISION INDUSTRY (ShenZhen) CO., LTD., Shenzhen City (CN); HON HAI PRECISION INDUSTRY CO., LTD., Tu-Cheng (TW)

(21) Appl. No.: 12/611,877

(22) Filed: Nov. 3, 2009

(30) Foreign Application Priority Data
Sep. 18, 2009 (CN) 200910307272.5

(51) Int. Cl. H01R 9/03

(52) U.S. Cl. 439/607.41

(57) ABSTRACT

A computer enclosure for a computer includes a rear wall, and a shielding panel attached to the rear wall. The shielding panel defines a plurality of I/O accessing holes corresponding to a plurality of connectors of the computer. A plurality of resilient contacting strips extends from edges of each of the accessing holes to resist against the corresponding connector extending therethrough.

### BACKGROUND

1. Technical Field

The present disclosure relates to a computer enclosure.

2. Description of the Related Art

A computer enclosure of a computer generally includes a shielding panel attached to a rear wall of the computer enclosure. The shielding panel defines a plurality of I/O (input/output) accessing holes corresponding to connectors of the computer, which are ready for being coupled to peripherals, such as a display and a printer. The connectors should be kept engaged with the shielding panel, otherwise electromagnetic waves will leak through the I/O accessing holes to undesirably interfere with equipment near the computer, or even cause injury to users.

### BRIEF DESCRIPTION OF THE DRAWINGS

FIG. 1 is an assembled, isometric view of a rear wall and a shielding panel of an exemplary embodiment of a computer enclosure, the shielding panel defines a plurality of I/O accessing holes each with a plurality of contacting strips.

FIG. 2 is a partial, sectioned view of FIG. 1 taken along line II-II.

FIG. 3 is a schematic view, similar to FIG. 2, showing a connector inserted in one of the accessing holes of FIG. 1.

### DETAILED DESCRIPTION

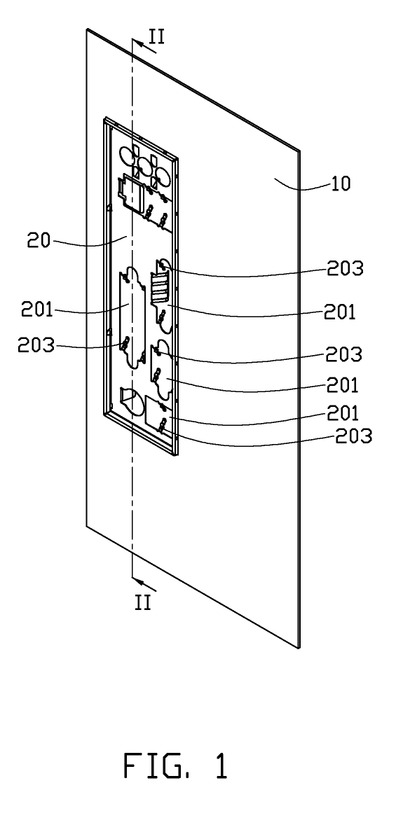

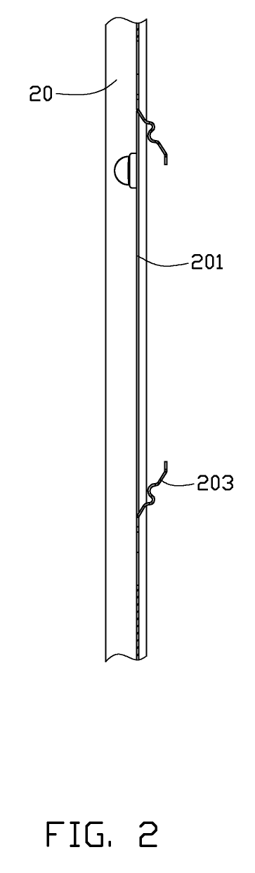

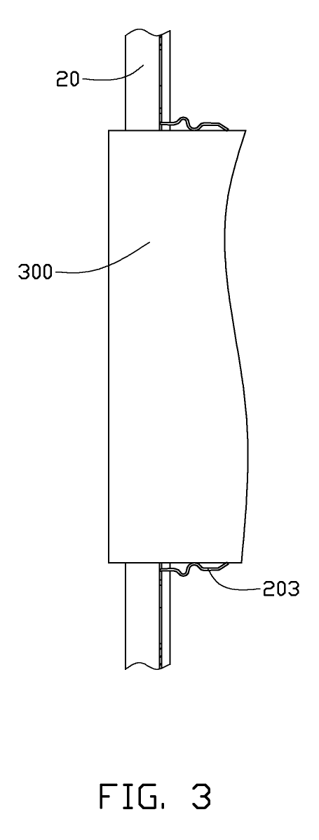

Referring to FIGS. 1-3, in an exemplary embodiment, a computer enclosure of a computer (not shown) includes a rear wall 10, and a shielding panel 20 attached to the rear wall 10. The shielding panel 20 defines a plurality of I/O (input/output) accessing holes 201, corresponding to a plurality of connectors 300 of the computer. The connectors 300 include a display connector, a printer connector, a keyboard connector, a mouse connector, and so on. The shielding panel 20 includes a plurality of resilient and electrically conductive contacting strips 203 arranged around each of the I/O accessing holes 201 and extending into the computer enclosure. In one embodiment, each of the contacting strips 203 around each of the holes 201 extends slantingly from edges of the accessing hole 201 towards the center of the accessing hole 201. Each of the contacting strips 203 is wavy in a lengthwise direction thereof to provide the contacting strip 203 with a elasticity.

To mount the connectors 300 to the shielding panel 20, the contacting strips 203 are urged to deform towards insides of the shielding panel 20. When the connectors 300 are inserted into the corresponding I/O accessing holes 201 of the shielding panel 20, the contacting strips 203 are released, thereby restoring to resist against the corresponding connectors 300. Therefore, the contacting strips 203 tightly contacting the connectors 300 prevent electromagnetic waves leaking from the I/O accessing holes 201 of the shielding panel 200.

It is believed that the present embodiment and its advantages will be understood from the foregoing description, and it will be apparent that various changes may be made thereto without departing from the spirit and scope of the description or sacrificing all of its material advantages, the example hereinbefore described merely being exemplary embodiments.

What is claimed is:

1. A computer enclosure of a computer comprising:
a rear wall;
a shielding panel attached to the rear wall and defining a plurality of I/O accessing holes corresponding to a plurality of connectors of the computer;
wherein the shielding panel comprises a plurality of resilient contacting strips around each of the accessing holes to resist against the corresponding connector extending therethrough.

2. The computer enclosure of claim 1, wherein the contacting strips around the accessing hole extend slantingly from edges of the accessing holes of the shielding panel, toward a center of the accessing hole.

3. The computer enclosure of claim 1, wherein each of the contacting strips waves in a lengthwise direction thereof to provide the contacting strip with a preferable elasticity.
